(19) United States
(12) Patent Application Publication
(10) Pub. No.: US 2004/0008423 A1
(43) Pub. Date: Jan. 15, 2004

(54) Visual teleconferencing apparatus

(76) Inventors: Edward C. Driscoll JR., Portola Valley, CA (US); Stanley P. DeMarta, Pleasanton, CA (US); Edward A. Burfine, Half Moon Bay, CA (US); Robert G. Hoffman, Fremont, CA (US)

Correspondence Address: BEVER, HOFFMAN & HARMS, LLP, 1432 CONCANNON BLVD., BLDG. G, LIVERMORE, CA, 94550, US

(21) Appl. No.: 10/462,217

(22) Filed: Jun. 12, 2003

Related U.S. Application Data
(63) Continuation-in-part of application No. 10/336,244, filed on Jan. 3, 2003.
(60) Provisional application No. 60/352,779, filed on Jan. 28, 2002.

(51) Int. Cl. G02B 13/06

(52) U.S. Cl. 359/725

(57) ABSTRACT

An audio/visual conference station that sits in the middle of a conference table, and includes a panoramic lens to capture and record a panoramic scene (e.g., meeting participants) that are surrounding the conference table and facing the conference station. The panoramic scene is captured as an annular image that is “unwrapped” and processed to form a rectangular panoramic image. The station also includes communication mechanisms to compress the panoramic image for transmission to a remote audio/visual conference station for display. Thus, people around the remote audio/visual conference station are able to both hear and see those at the local audio/visual conference station and vice versa. In addition, the audio/visual conference station includes several independently controlled display devices that allow meeting participants to enhance selected portions of the panoramic image, such as a current speaker.

### RELATED APPLICATIONS

The present application is a Continuation-In-Part of and claims the benefit of U.S. Utility patent application Ser. No. 10/336,244 by Edward C. Driscoll, Jr. and John L. W. Furlan, filed Jan. 3, 2003, and is incorporated herein in its entirety by reference.

The present application also claims the benefit of U.S. Provisional Patent Application serial No. 60/352,779 by Edward C. Driscoll, Jr. and John L. W. Furlan, filed Jan. 28, 2002, and is incorporated herein in its entirety by reference.

### BACKGROUND OF THE INVENTION

1. Field of the Invention

This invention relates to the field of video conferencing.

2. Background

Video conferencing systems have been difficult to use and setup, and usually require special configurations and multiple cameras. In comparison, even high-quality audio conference telephones have a very small footprint and are simple to use.

A major problem with conventional (audio-only) teleconferencing systems is that it is difficult to determine who is on the other end of the line, and who is speaking or interjecting words. Voices are identifiable only by their sound qualities (accent, pitch, inflection). In addition, the presence of completely silent parties cannot be determined or verified. Brief interjections can even complicate verbal identity determination because they are so short.

One reason for the slow adoption of video conferencing systems is that these systems are generally not very useful in a conference room setting. For example, a typical meeting includes a number of people, generally sitting around a table. Each of the people at the meeting can observe all of the other participants, facial expressions, secondary conversations, etc. Much of this participation is lost using prior art video-conferencing systems.

One major problem with conventional videoconferencing systems is that they convert a meeting taking place over a table into a theatre event. That is, a meeting where everyone is facing a large television at the end of the room that has a distracting robotic camera on top of it. This is also true of the remote site where another “theatre” environment is set up. Thus, both the local and remote sites seem to be sitting on a stage looking out at the other audience. This arrangement inhibits and/or masks ordinary meeting behavior, where body language, brief rapid-fire verbal exchanges and other non-verbal behavior are critical. It also prevents the parties in each “theatre” from effectively meeting among their own local peers, because they are all forced to keep their attention at the television at the end of the room.

It would be advantageous to have a visual conferencing system that is simple to use, has only one lens, has a small footprint and can be positioned in the middle of a conference table. It would also be advantageous to have a visual conferencing system in which selected portions of a panoramic image could be isolated and enhanced without requiring expensive camera systems and remote controlled mechanisms.

### SUMMARY OF THE INVENTION

The present invention is directed to a visual conference station that includes a novel panoramic lens/imaging system mounted such that the panoramic lens and associated image sensor capture a panoramic scene surrounding the visual conference station (e.g., a group of people sitting around a conference table on which the visual conference station is placed). According to an aspect of the present invention, the optical axis of the panoramic lens is aligned vertically (i.e., perpendicular to an underlying table), and the panoramic scene is captured as an annular image by the image sensor. Accordingly, the visual conference station facilitates a natural “people-around-a-table” meeting arrangement where people face both those present around a conference table and remote participants (i.e., via the panoramic lens/imaging system).

According to an aspect of the present invention, the panoramic lens is aspherical, and formed such that the panoramic image is anamorphic, with a higher degree of resolution near the lens horizon. This arrangement provides enhanced detail in the region that is typically of most interest (i.e., the face and upper torso of meeting participants sitting around a conference table) to an audience viewing the panoramic image.

According to an embodiment of the present invention, the visual conference station includes a housing having a base and a central post extending upward from the base, and the panoramic lens is mounted at an upper end of the post such that the panoramic lens is maintained a predetermined distance above the underlying conference table. In one embodiment, the panoramic lens is maintained a distance in the range of four to 16 inches above the underlying table top, and more preferably in the range of eight to 12 inches, thereby maintaining the horizon (zero inclination plane) of the panoramic lens approximately at the eye level of meeting participants sitting around a conference table on which the station is placed. By positioning the panoramic lens in this preferred range, and by forming the panoramic lens such that the anamorphic image includes a higher resolution adjacent the horizon, high quality panoramic image data is generated that can be studied in detail by meeting participants.

According to another aspect of the present invention, the optical axis of the panoramic lens is aligned vertically (i.e., perpendicular to the underlying table), and the panoramic scene is captured as an annular image by the image sensor. The annular image data is then “unwrapped” (processed) to form a rectangular panoramic image that is compressed for transmission to another station (e.g., during a live visual conference session), or for storage for future review.

Each station is adapted to receive and decompress panoramic image data (e.g., from another station), and to transmit the panoramic image data to one or more display devices. According to an embodiment of the present invention, each display device is adapted to provide a user several display options, including selecting and enhancing one or more specific regions of the panoramic image, thereby allowing the user to view the specific regions in greater detail. In one embodiment, the specific regions are subjected to image processing (e.g., for zoom, inclination angle, and Keystone correction) to present a high quality view image. In another embodiment, a speaker's location is triangulated using an array of microphones mounted on the visual conference station, and the speaker is automatically identified (e.g., highlighted) in the panoramic image and/or presented in a separate enlarged view. In yet another embodiment, a user is able to present shared documents along with the panoramic/view images.

The foregoing and many other aspects of the present invention will no doubt become obvious to those of ordinary skill in the art after having read the following detailed description of the preferred embodiments that are illustrated in the various drawing figures.

### DESCRIPTION OF THE DRAWINGS

FIG. 1A perspective top side view of a visual conference station in accordance with a first embodiment of the present invention;

FIG. 1B is a simplified cross-sectional side view showing the visual conference station of FIG. 1A;

FIG. 1C is a simplified cross-sectional side view showing a lens system utilized in the visual conference station of FIG. 1A according to a specific embodiment of the present invention;

FIG. 1D shows an exemplary annular image generated by the visual conference system of FIG. 1A;

FIG. 1E is a perspective top side view showing visual display devices detached from the housing of the visual conference station of FIG. 1A;

FIG. 2A illustrates a side view of the visual conference station of FIG. 1A in use in accordance with a preferred embodiment;

FIG. 2B illustrates a top view of arrangement show in FIG. 2A;

FIG. 3A illustrates the communications environment of the visual conference station in accordance with an embodiment of the present invention;

FIG. 3B illustrates the communications environment of the visual conference station in accordance with another embodiment of the present invention;

FIG. 4 illustrates the visual conference station system architecture in accordance with an embodiment of the present invention;

FIG. 5 illustrates an initialization procedure in accordance with an embodiment of the present invention;

FIG. 6 illustrates a visual receive initialization procedure in accordance with another embodiment of the present invention;

FIG. 7 illustrates a visual send thread procedure in accordance with an embodiment of the present invention;

FIG. 8A illustrates a visual display thread procedure in accordance with an embodiment of the present invention;

FIG. 8B is a screen-shot showing an exemplary panoramic image and associated enhanced views generated in accordance with an embodiment of the present invention;

FIG. 9A illustrates a conference registration process in accordance with an embodiment of the present invention;

FIG. 9B illustrates a visual information distribution process in accordance with an embodiment of the present invention; and

FIG. 10 is a perspective view showing a top side view of a visual conference station in accordance with yet another embodiment of the present invention.

### DETAILED DESCRIPTION OF THE INVENTION

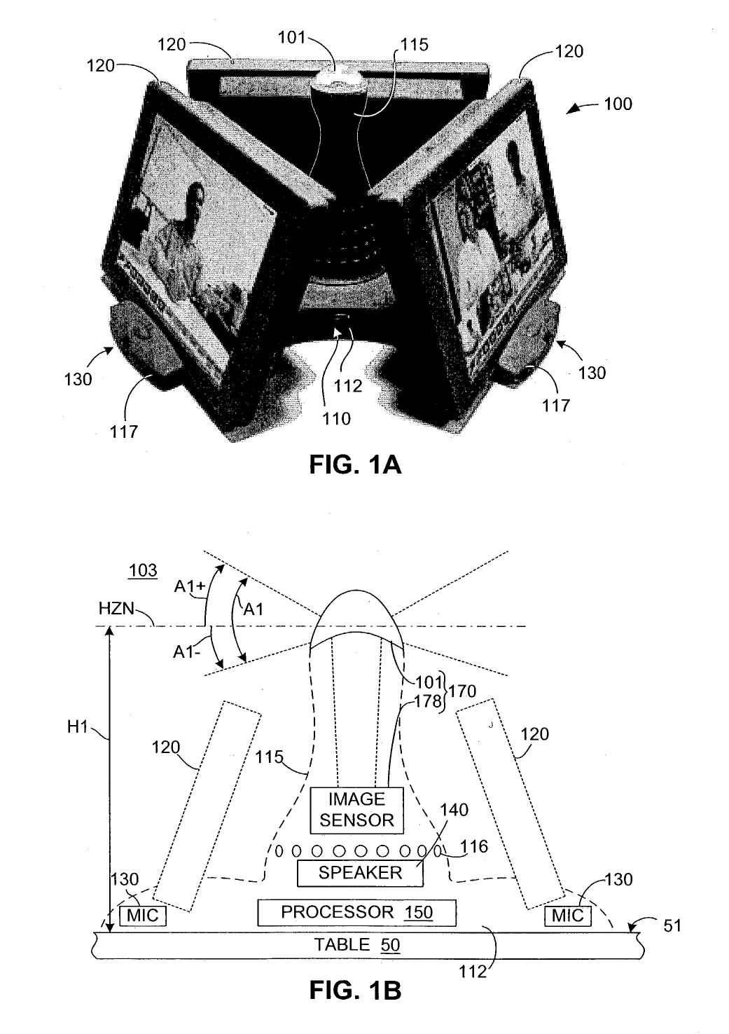

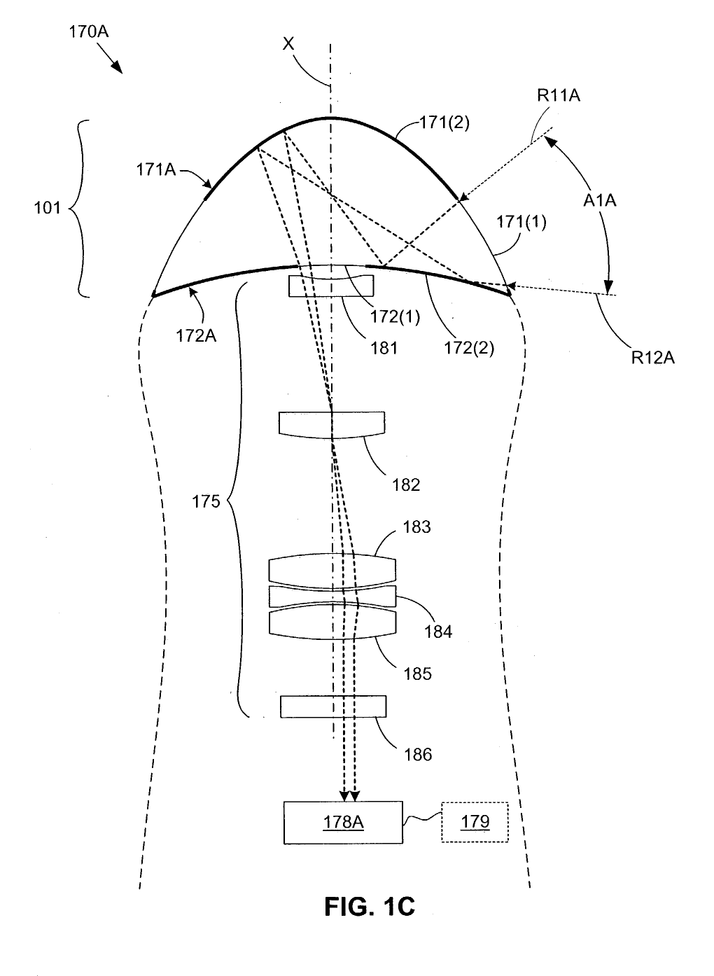

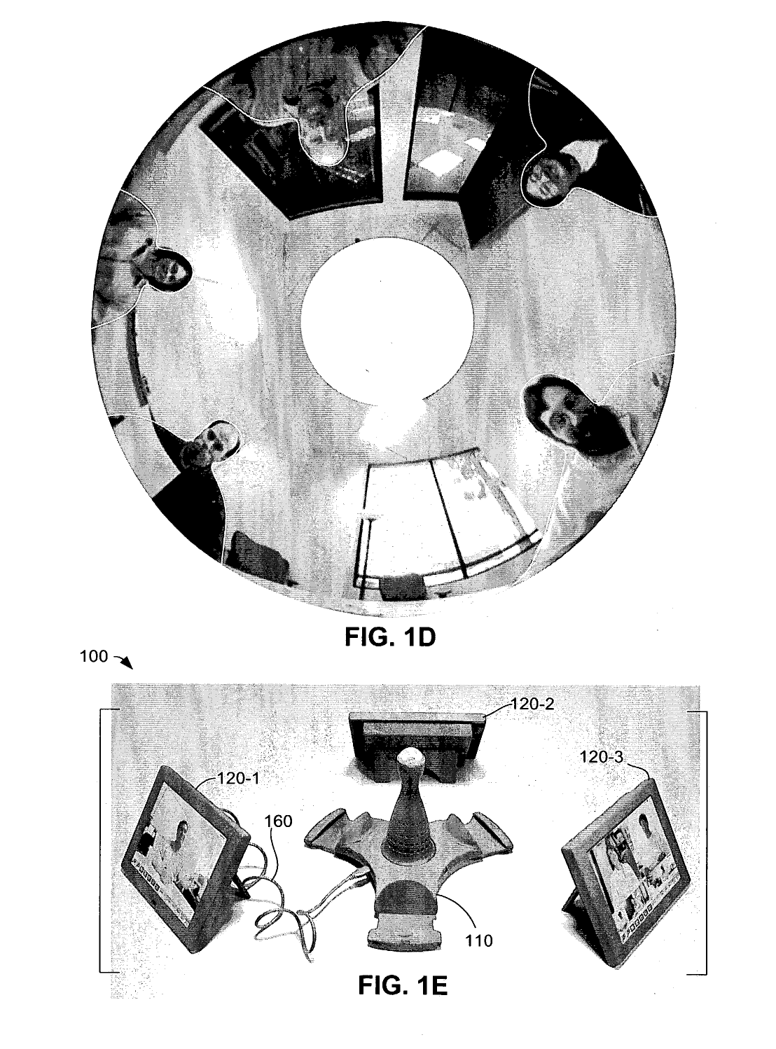

FIG. 1A is a perspective view showing an exemplary visual conference station 100 according to an embodiment of the present invention. Visual conference station 100 generally includes a panoramic lens 101 mounted on a housing 110 for capturing light from substantially 360-degree (panoramic) region surrounding visual conference station 100, and one or more visual display devices 120 for displaying images received from a second visual conferencing station (not shown) during a video conferencing session. Each of these processes (i.e., capturing a local panoramic scene and displaying a remote panoramic scene) is described in detail below.

As indicated in FIG. 1A and FIG. 1B, housing 110 includes a central base portion 112, a central post 115 extending upward from base portion 112, and three foot portions 117 (two shown) that extend radially outward from base portion 112 in a triangular pattern. Housing 110 is formed from one or more pieces of molded plastic, and is constructed to containing and protecting the various electronic and optical components of visual conference station 100 (described below). In addition, housing 110 is constructed to perform several functions.

First, as FIG. 1B, central post 115 of housing 110 is constructed such that panoramic lens 101 is fixedly maintained a predetermined height H1 above the upper surface 51 of a table 50 or other support structure. The height H1 is generally in the range of four to 16 inches, and more preferably in the range of 8 to 12 inches. Maintaining the height H of panoramic lens 101 above table 50 in the preferred range provides several benefits. First, maintaining panoramic lens 101 in the preferred range positions the horizon HZN (zero degree) angle of panoramic lens 101 at approximately eye level with conference participants. As described further below, this facilitates a natural “people-around-a-table” meeting arrangement where people face both those present around a conference table and remote participants (i.e., via panoramic lens 101). Second, maintaining panoramic lens 101 in the preferred range facilitates the use of standard sized visual display devices 120, which are described in additional detail below.

A second function provided by housing 110 is the positioning of microphones 130 and a central speaker 140 such that both enhanced sound pickup is achieved, and necessary noise cancellation is implemented using a suitable sound processing method. In a preferred embodiment, three microphones 130 are arranged in a triangular arrangement and located at the end of foot portions 117 (as indicated in FIG. 1A), and a central speaker 140 is located in base 112 and emits sound through circular openings 116 formed in a lower portion of central post 115. Suitable noise cancellation is performed, for example, by a central processor 150 using known techniques.

Referring to the upper portion of FIG. 1B, panoramic lens 101 forms the key portion of an imaging system (camera) 170 that includes an imaging device 178 located inside central post 115. Panoramic lens 101 receives light from substantially 360-degree (panoramic) region around a planar horizon line of panoramic lens 101 (i.e., surrounding and that has a vertical field-of-view 103 throughout). As discussed above, panoramic lens 101 is positioned such that a horizon (zero horizontal axis) HZN of lens 101 is aligned at approximately the eye level of conference participants (i.e., people sitting around a conference table). Further, as discussed in additional detail below, light from the 360° panoramic region surrounding visual conference station 100 is reflected and refracted by lens 101 to form an annular image that is captured by imaging device 178. In one embodiment, panoramic lens 101 is formed such that this annular image is anamorphic. In particular, the annular image is distorted to collect a larger amount of light from an angular region A1 relative to the horizon HZN than from regions above and below angular region A1. In one embodiment, angular region A1 includes a positive angle A1+ (i.e., above horizon HZN) of approximately 45°, and a negative angle A1− of approximately 15°. The benefit of capturing more light from angular region A1 than from regions above or below angular region A1 is that, in a typical conference setting, most of the interesting visual information is located in this region (i.e., the faces of people sitting around a conference table). Note that, as discussed below, correcting the displayed image to account for the anamorphic distortion is performed using substantially conventional techniques.

FIG. 1C is a cross-sectional side view showing an imaging system 170A utilized by visual conference station 100 according to an embodiment of the present invention. Imaging system 170A includes panoramic lens 101A, a secondary optical system 175, and a image sensor 178A. Imaging system 170A is described briefly below, and is described in further detail in co-owned and co-pending U.S. patent application Ser. No. xx/xxx,xxx [Atty Docket No. BEH-019] entitled “PANORAMIC IMAGING SYSTEM” by Edward P. Wallerstein et al., which is incorporated herein in its entirety.

Panoramic lens 101A is symmetric about an optical axis (axis of rotation) X and includes a convex surface 171A and a concave surface 172A. Convex surface 171A is an aspheric surface (i.e., the cross section of convex surface 171A follows a first aspheric curve) and includes a transmissive portion 171(1) (indicated by the thin line) surrounding an internally reflective portion 171(2) (indicated by the dark line). Concave surface 172A follows a second aspheric curve and includes an internally reflective portion 172(2) (indicated by the dark line) surrounding a transmissive (or refractive) portion 172(1) (indicated by the thin line).

Lens 101A is formed using an optically transparent material (e.g., molded plastic), and so internally reflective portions 171(2) and 172(2) can be created by covering the appropriate portions of lens 101A with a reflective coating (e.g., aluminum, silver, or gold formed on the transparent lens material using vacuum, chemical, or sputter deposition techniques) that reflects light within lens 101A. Meanwhile, transmissive portions 171(1) and 172(1) can simply be left uncoated, or can be coated with an anti-reflective coating to improve transmission characteristics.

In use, light from a 360-degree surrounding panoramic scene enters lens 101A through transparent portion 171(1) of convex surface 171A. The entering light spans an unbroken included angle A1A that can include light rays from above the horizon (i.e., the plane perpendicular to axis of rotation X), such as light ray R11A, and light rays from below the horizon, such as light ray R12A.

When light enters transparent portion 171(1), the light is refracted slightly downward at the convex surface towards internally reflective portion 172(2) of concave surface 172A. The light is then reflected upwards by internally reflective portion 172(2) towards internally reflective portion 171(2) of convex surface 171A, which in turn reflects the light back downwards towards transmissive portion 172(1) of concave surface 172A, where it exits lens 101A. Refraction at the curved surface of transmissive portion 172(1) decreases the angle the exiting light rays make with axis of rotation X.

In this manner, a 360-degree surrounding scene can be captured into a single light beam by (monolithic) lens 101A without any additional optical elements. The exiting beam can then be manipulated and/or captured by secondary optical system 175 and image sensor 178A.

Secondary optical system 175 can include any number and type of optical elements. For exemplary purposes, secondary optical system 175 is depicted as including a field flattening lens 181, a scaling lens 182, a set of color correcting lenses 183, 184, and 185, and an IR (infrared) filter 186. Therefore, light from a 360-degree panoramic scene entering lens 101A via transparent region 171(1) and exiting from transparent region 172(1) is corrected for image flatness, scale, and color accuracy by secondary optical system 175 before being detected or captured by imaging device 178A. As is well known in the art, various other arrangements and/or selections of optical elements can be included in secondary optical system 175. Secondary optical system 175 simply provides an optical pathway (that can provide various types of optical manipulations) between panoramic lens 101A and image sensor 178A.

Image sensor 178A can comprise any type of photosensing element, such as a photosensitive film (i.e., chemical based film) or a digital image sensor (such as a charge-coupled device (CCD) or CMOS image sensor), and can be coupled to an optional image processor 179 (indicated by the dotted line) to provide additional digital image manipulation.

In addition to the specific lens system 170A, described above, other panoramic lens types may be utilized to facilitate functional operation of visual conference station 100. For example, one alterative panoramic lens is disclosed in U.S. Pat. No. 6,175,454 by Hoogland and assigned to Be Here Corporation. Another alternative embodiment uses a panoramic lens such as disclosed in U.S. Pat. No. 6,341,044 or 6,373,642 by Driscoll and assigned to Be Here Corporation. These lenses generate annular images of the surrounding panoramic scene. However, other types of wide-angle lenses or combination of lenses can also be used (for example fish-eye lenses, 220-degree lenses, or other lenses that can gather light to illuminate a circle). A micro-panoramic lens provides benefits due to its small size. Although the subsequent description is primarily directed towards a panoramic lens that generates an annular image, the invention encompasses the use of wide-angle lenses (such as fish-eye lenses or very-wide angle lenses (for example a 220-degree wide-angle lens)).

FIG. 1D is a photograph depicting an exemplary annular image captured by an imaging system similar to imaging system 170A (described above). The annular image shown in FIG. 1D depicts a group of people sitting around a table in a conference room. As such, the annular image shows that a visual conference station similar to that shown in FIG. 1A can be used to record images (i.e., light) received from a panoramic image surrounding the visual conference station, thereby facilitating the videoconferencing process described below.

Returning to FIG. 1A, in one embodiment visual display devices 120 are standard 10.1″ touchscreen-type devices. In addition to displaying videoconferencing data (described below), the touchscreen function provided by visual display devices 120 facilitate user command entry by emulating a control keypad using known techniques. For example, when initiating a videoconferencing session, an alphanumeric or numerical keypad is displayed on one or more visual display devices 120 that is manipulated by a user to, for example, select a videoconferencing address or selected telephone number. In other embodiments, non-touchscreen displays may be utilized, but a separate keyboard/keypad would be required.

FIG. 1E is a photograph showing visual conference station 100 arranged such that visual display devices 120-1, 120-2, and 120-3 are detached from housing 110. According to another aspect of the present invention, visual display devices 120-1 through 120-3 are detachable mounted onto housing 110, and are linked by wire or wireless communication methods to visual data generation circuitry mounted in housing 110 in order to display images received from a second visual conferencing station (not shown) during a video conferencing session. For example, as shown in FIG. 1E, visual display device 120-1 is linked by a cable 160 to housing 110. Conversely, visual display devices 120-2 and 120-3 are adapted to receive video signals transmitted from corresponding transmission devices included in housing 110 using known techniques.

Although not shown in FIG. 1A, visual conference station 100 includes communication ports for connection to the telephone network and/or a high-speed communication network (for example, the Internet). In addition, visual conference station 100 can include connections for separate speakers, microphones, displays, and/or computer input/output busses. In addition, wireless communications utilized to transmit videoconferencing images to wireless visual display devices (e.g., visual display devices 120-2) may also be utilized to transmit visual teleconference images and/or sounds to laptop computer platforms.

According to another aspect of the present invention, a video teleconferencing system is formed by linking two or more visual conference stations 100 using a high-speed network connection (e.g., the Internet, a DSL line, or a cable modem) or a standard POTS telephone line. Like a traditional high-quality conference phone, each visual conference station 100 is placed in the middle of a table around which the people participating in a conference. One visual conference station 100 communicates with another visual conference station 100 to exchange audio information acquired through microphones 130 and panoramic image information captured by panoramic lens 101. When received, the audio information is reproduced using speaker 140 and the image information is presented using the visual display devices 120.

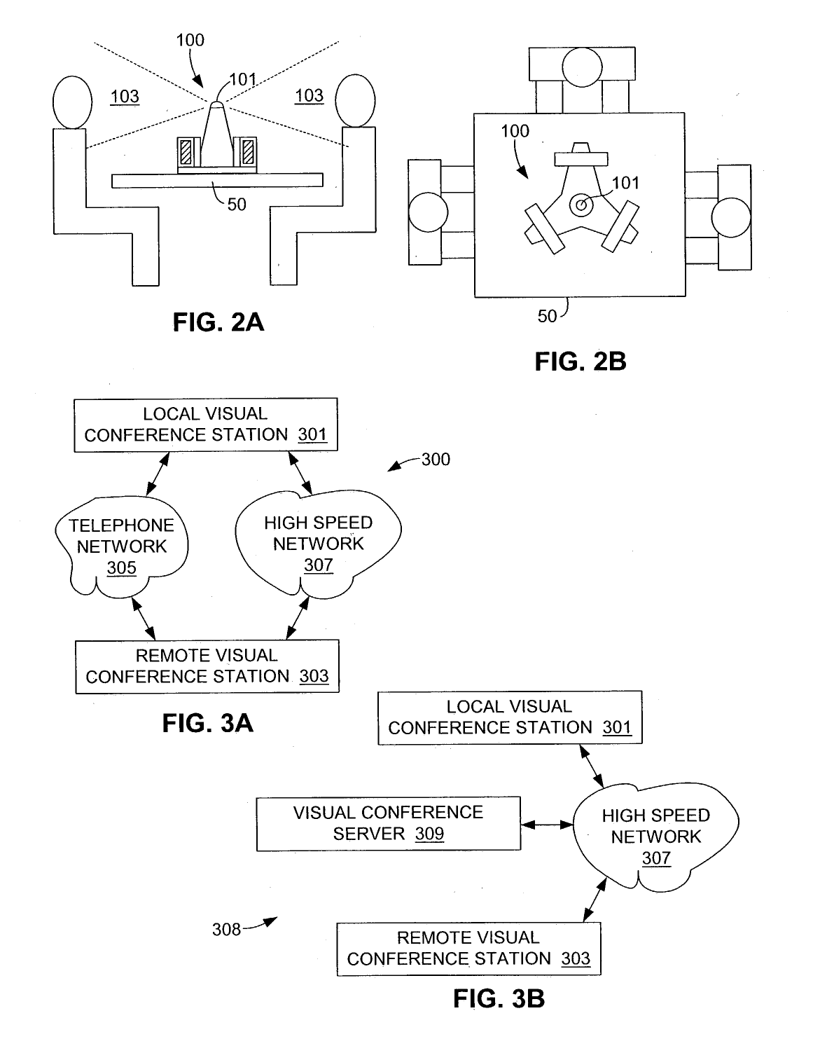

FIG. 2A illustrates a side view of visual conference station 100 in use on a table 50 with two shown people. Note that the vertical field-of-view 103 captures the head and torso or the meeting participants. In some embodiments, the vertical field-of-view 103 can be such that a portion of the table is also captured. FIG. 2B illustrates the placement of visual conference station 100. Each of the people around the table is captured by the 360-degree view of panoramic lens 101.

FIG. 3A illustrates a first video conferencing system (communications environment) 300 including a local visual conference station 301 and a remote visual conference station 303. In one embodiment, local visual conference station 301 and remote visual conference station 303 communicate using both a telephone network 305 and a high-speed network 307. The telephone network 305 can be used to communicate audio information while the high-speed network 307 can be used to communicate visual information. This arrangement prevents interruption of a meeting by loss of the high-speed network by allowing participants to continue to continue talking in a manner similar to that used in conventional telephone conferencing. In another embodiment, both the visual and audio information is communicated over the high-speed network 307. In yet another embodiment, both the visual and audio information may be communicated over the telephone network 305. Thus, the conference participants at a first site (i.e., surrounding local visual conference station 301) can view the conference participants at a second site (i.e., surrounding remote visual conference station 303) while the conference participants at the second site can also view the conference participants at the first site.

FIG. 3B illustrates a second video conferencing system (communications environment) 308 wherein remote visual conference station 303 and local visual conference station 301 communicate with a visual conferencing server 309 over a network. Visual conferencing server 309 connects multiple visual conference stations together. Local visual conference station 301 sends its annular (or circular) image to visual conferencing server 309. Visual conferencing server 309 then transforms the annular image into a panoramic image and supplies the panoramic image to the appropriate stations in the conference (such as at least one remote visual conference station 303 and/or local visual conference station 301). Thus, the visual conferencing server 309 can offload the image processing computation from the stations to visual conferencing server 309. The local visual conference station 301 also provides the visual conferencing server 309 with information about the characteristics of the sent image. This information can be sent with each image, with the image stream, and/or when local visual conference station 301 registers with visual conferencing server 309. Thus, the conference participants at the one site can view the conference participants at the other site while the conference participants at the other site can also view the conference participants at the one site.

Another capability of the system shown in FIG. 3B is that it allows one-way participation. That is, participants from the one site can be viewed by a multitude of other sites (the station at the one site sending audio/visual information to the server that redistributes the information to corresponding remote visual conference stations 303 at each of the other sites). This allows many observer sites to monitor a meeting at the one site.

One skilled in the art will understand that the network transmits information (such as data that defines a panoramic image as well as data that defines a computer program). Generally, the information is embodied within a carrier-wave. The term “carrier-wave” includes electromagnetic signals, visible or invisible light pulses, signals on a data bus, or signals transmitted over any wire, wireless, or optical fiber technology that allows information to be transmitted over a network. Programs and data are commonly read from both tangible physical media (such as a compact, floppy, or magnetic disk) and from a network. Thus, the network, like a tangible physical media, is a computer usable data carrier.

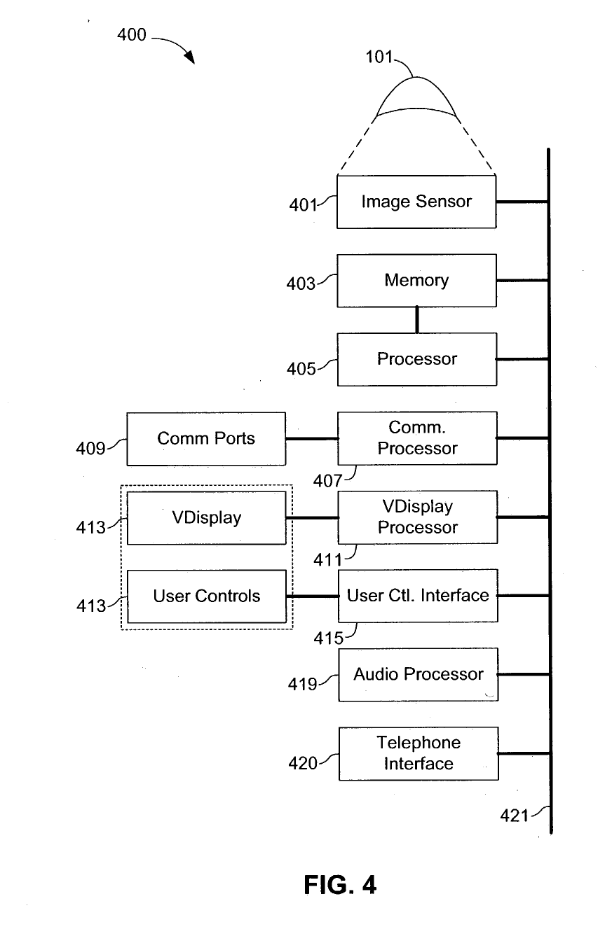

FIG. 4 illustrates a visual conference station system architecture 400 that includes an image sensor 401 on which the panoramic lens 101 is optically (and in a preferred embodiment also physically) attached. The panoramic lens 101 captures light from a 360-degree panoramic scene around the lens that is within the vertical field-of-view 103. This light from the panoramic scene is focused on the image sensor 401 where an annular or wide-angle image of the panoramic scene is captured. The image sensor 401 can be any of the commercially available image sensors (such as a CCD or CMOS sensor). The visual conference station system architecture 400 also includes a memory 403, a control processor 405, a communication processor 407, one or more communication ports 409, a visual display processor 411, a visual display 413, a user control interface 415, a user control input 417, an audio processor 419, a telephone line interface 420 and an electronic data bus system 421. One skilled in the art will understand that this architecture can be implemented on a single integrated circuit as well as by using multiple integrated circuits and/or a computer.

The memory 403 and the control processor 405 can communicate through the electronic data bus system 421 and/or through a specialized memory bus. The control processor 405 can be a general or special purpose programmed processor, an ASIC or other specialized circuitry, or some combination thereof.

The control processor 405 communicates to the image sensor 401 to cause a digitized representation of the captured panoramic image (the captured visual information) to be transferred to the memory 403. The control processor 405 can then cause all or part of the panoramic image to be transferred (via the communication processor 407 and the one or more communication ports 409 or the telephone line interface 420) and/or presented using the visual display processor 411 as conditioned by the user control input 417 through the user control interface 415.

In addition, a panoramic image can be received by the one or more communication ports 409 and/or the telephone line interface 420, stored in the memory 403 and presented using the visual display processor 411 and the visual display 413.

In one embodiment of the visual conference station system architecture 400, the local visual conference station 301 and the remote visual conference station 303 directly exchange their respective panoramic images (either as an annular representation or as a rectangular panoramic representation) as well as the captured audio information.

In another preferred embodiment, the remote visual conference station 303 and the local visual conference station 301 communicate with the visual conferencing server 309 as previously discussed.

One skilled in the art would understand that although the visual conference station 100 illustrated in FIG. 1B incorporates visual display devices 120, microphones 130, and speaker 140, other preferred embodiments need only provide interfaces to one or more of these devices such that the audio and visual information is provided to the audio/visual devices through wire, wireless, and/or optical means. Further, that the functions of the control unit (keypad) can be provided by many different control mechanisms including (but not limited) to hand-held remote controls, network control programs (such as a browser), voice recognition controls and other control mechanisms. Furthermore, such a one would understand that the audio processor 419 typically is configured to include both an audio output processor used to drive a speaker and an audio input processor used to receive information from a microphone.

In yet another embodiment, the video information from the image sensor 401 can be communicated to a computer (for example using a computer peripheral interface such as a SCSI, Firewire®, or USB interface). Thus, one preferred embodiment includes an assembly comprising the panoramic lens 101 and the image sensor 401 where the assembly is in communication with a computer system that provides the communication, audio/visual, user, and networking functionality.

In still another embodiment, the visual conference station 100 can include a general-purpose computer capable of being configured to send presentations and other information to the remote stations as well as providing the audio/visual functions previously described. Such a system can also include (or include an interface to) a video projector system.

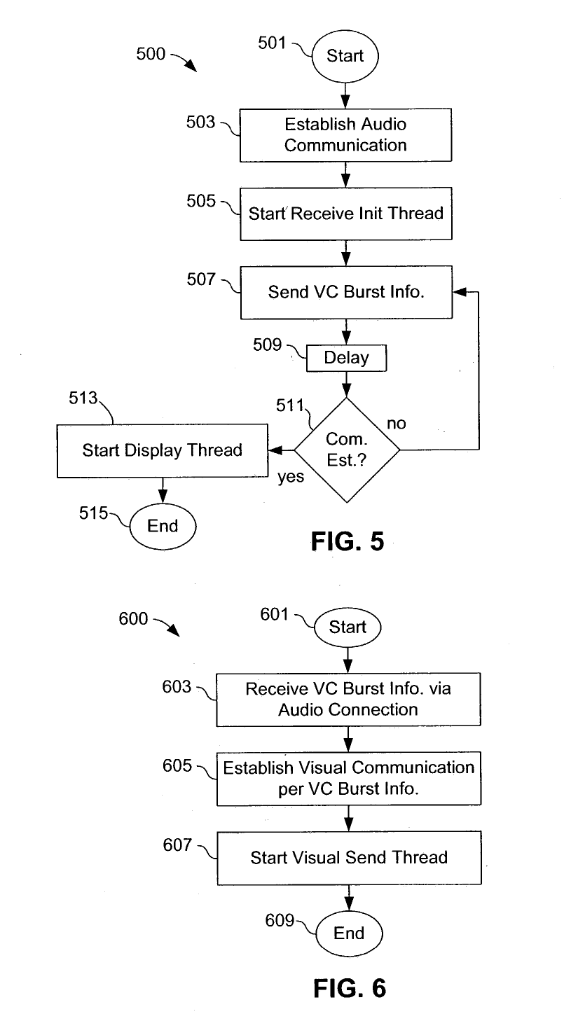

FIG. 5 illustrates an ‘initialization’ procedure 500 that can be invoked when the visual conference station 100 is directed to place a visual conference call. The ‘initialization’ procedure 500 initiates at a ‘start’ terminal 501 and continues to an ‘establish audio communication’ procedure 503 that receives operator input. The visual conference station 100 uses an operator input mechanism (for example, a keypad, a PDA, a web browser, etc.) to input the telephone number of the visual conference station 100 at the remote site. The ‘establish audio communication’ procedure 503 uses the operator input to make a connection with the remote visual conference station. This connection can be made over the traditional telephone network or can be established using network telephony.

Once audio communication is established, the ‘initialization’ procedure 500 continues to a ‘start visual receive initialization thread’ procedure 505 that starts the visual receive initialization thread that is subsequently described with respect to FIG. 6.

Once audio communication is established, audio information can be exchanged between the stations over the telephone line or the high-speed link. Thus, captured audio information captured by a microphone at the local site is sent to the remote site where it is received as received audio information and reproduced through a speaker.

A ‘send visual communication burst information’ procedure 507 encodes the Internet address of the local visual conference station along with additional communication parameters (such as service requirements, encryption keys etc.) and, if desired, textual information such as the names of the people in attendance at the local visual conference station, and/or information that identifies the local visual conference station. Then a ‘delay’ procedure 509 waits for a period of time (usually 1-5 seconds). After the delay, a ‘visual communication established’ decision procedure 511 determines whether the remote visual conference station has established visual communication over a high-speed network with the local visual conference station. If the visual communication has not been established, the ‘initialization’ procedure 500 returns to the ‘send visual communication burst information’ procedure 507 to resend the visual communication information. Although not specifically shown in FIG. 5, if the visual communication is not established after some time period, this loop ends, and the visual conference station operates as a traditional audio conference phone.

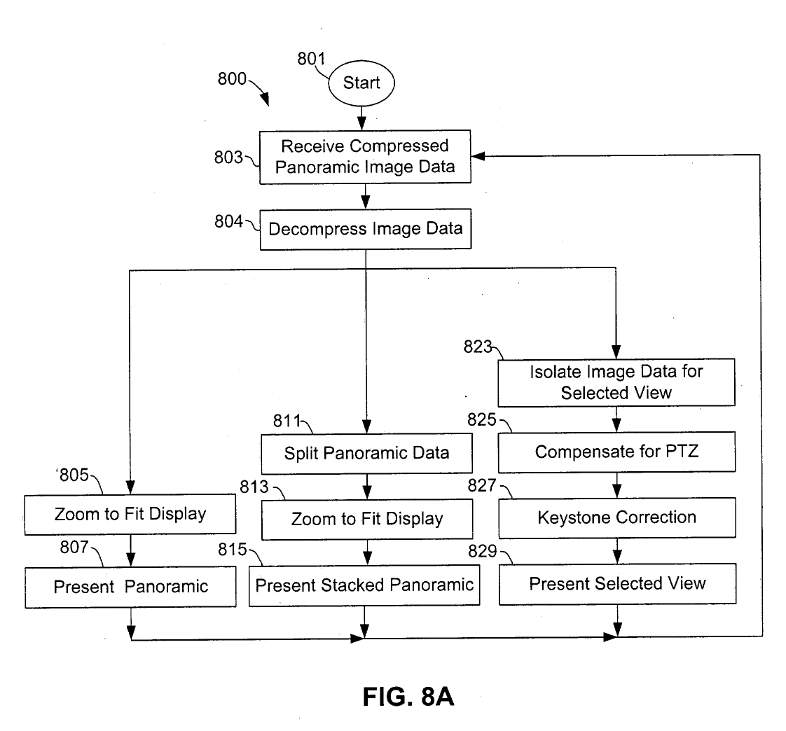

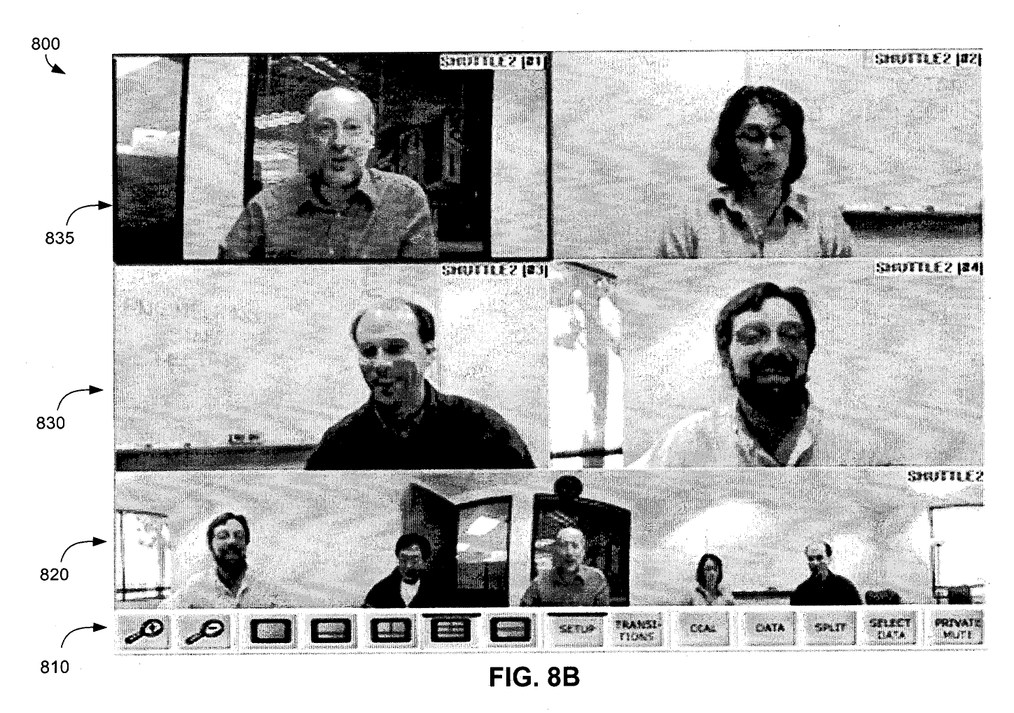

However, if the ‘visual communication established’ decision procedure 511 determines that visual communication has been established with the remote visual conference station, the ‘initialization’ procedure 500 continues to a ‘start display thread’ procedure 513 that initiates the display thread process as is subsequently described with respect to FIG. 8.

The ‘initialization’ procedure 500 exits at an ‘end’ terminal 515.

One skilled in the art will understand that there exist other protocols for establishing communication between the local visual conference station 301 and the remote visual conference station 303 other than the one just described. These other protocols will be useful in homogeneous networking environments where both audio and visual information are transmitted over the same network (for example, the internet or the telephone network).

FIG. 6 illustrates a visual receive initialization procedure 600 that is invoked by the ‘start visual receive initialization thread’ procedure 505 of FIG. 5 and that initiates at a ‘start’ terminal 601. The visual receive initialization procedure 600 waits at a ‘receive visual communication burst’ procedure 603 for receipt of the visual communication burst information sent by the other visual conference station. Once the visual communication burst information is received, it is parsed and the information made available as needed. An ‘establish visual communication procedure 605 uses information received from the ‘receive visual communication burst’ procedure 603 to initiate communication of visual information with the visual conference station that sent the visual communication burst information. This establishment of communication between the visual conference stations can be accomplished by many protocols (such as by exchange of UDP packets or by establishment of a connection using an error correcting protocol and can use well-established Internet streaming protocols).

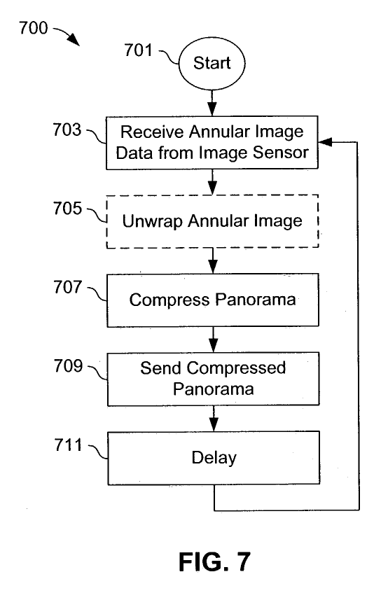

Once the visual communication between the visual conference stations is established, the visual receive initialization procedure 600 continues to a ‘start visual send thread’ procedure 607 that initiates the visual send thread that is subsequently described with respect to FIG. 7. Then the visual receive initialization procedure 600 completes through the ‘end’ terminal 609.

FIG. 7 illustrates a visual send thread 700 that initiates at a ‘start’ terminal 701 after being invoked by the ‘start visual send thread’ procedure 607 of FIG. 6. A ‘receive annular image’ procedure 703 reads the annular (or wide angle) image captured by the panoramic lens 101 from the image sensor 401 into the memory 403. Then an ‘unwrap annular image’ procedure 705 transforms the captured visual information (the annular or wide-angle image) into a panoramic image (generally, rectangular in shape). A ‘compress panoramic image’ procedure 707 then compresses the panoramic image or the captured visual information (either by itself, or with respect to previously compressed panoramic images). A ‘send compressed panoramic’ procedure 709 then sends the compressed visual information to the other visual conference station for display (as is subsequently described with respect to FIG. 8). The compressed panoramic data may be sent as a continuous single panoramic format, or split and transmitted in a “stacked” arrangement (described below). A ‘delay’ procedure 711 then waits for a period. The visual send thread 700 returns to the ‘receive annular image’ procedure 703 and repeats until the visual portion of the conference call is terminated (for example, by ending the call, by explicit instruction by an operator etc.). In addition, an operator at the local visual conference station can pause the sending of visual images (for example, using a control analogous to a visual mute button).

The ‘unwrap annular image’ procedure 705 need not be performed (hence the dashed procedure box in FIG. 7) if this function is provided by a server (such as the visual conferencing server 309).

The ‘compress panoramic image’ procedure 707 can compress the panoramic image using MPEG compression, JPEG compression, JPEG compression with difference information, or any techniques well known in the art to compress a stream of images. In addition, one skilled in the art will understand that the ‘unwrap annular image’ procedure 705 and the ‘compress panoramic image’ procedure 707 can be combined into a single step.

FIG. 8A illustrates a display thread 800 used to display the visual information sent by the ‘send compressed panoramic’ procedure 709 of FIG. 7. The display thread 800 is invoked by the ‘start display thread’ procedure 513 of FIG. 5 and initiates at a ‘start’ terminal 801. A receive compressed panorama’ procedure 803 then receives the compressed panorama information (the received visual information) sent by the other visual conference station. The compressed panoramic is then decompressed using known techniques (procedure 804), and is then displayed on a selected visual display device according to a user's display preference. In one embodiment, a user is provided several selections regarding the format used to display the image data associated with the decompressed panoramic image. For example, the user may elect to only display the panoramic image in one elongated rectangular region on the display device. In this instance, as indicated on the left side of FIG. 8A, the panoramic image data may be adjusted to fit the particular display device (block 805), and then presented on the display device (block 807). In addition, in order to provide enhanced resolution and to better utilize the display area (screen) of a corresponding visual display device (e.g., a 10.1″ touchscreen device), the user may elect to display the panoramic image in a “stacked” arrangement wherein a first half of the panoramic image (e.g., 0 through 180 degrees) is presented in an upper half of the screen, and a second half of the panoramic image (e.g., 180 through 360 degrees) is presented in a lower half of the screen (block 815). Note that displaying the panoramic image in a “stacked” arrangement requires splitting the panoramic image data into two portions (block 811), and may involve compensating for “zoom” (i.e., enlarging or “zooming” the image data portions for the particular display; block 813).

According to another aspect of the present invention, in addition to displaying panoramic and stacked panoramic images, each visual display device is adapted to operate as a virtual camera that allows the user to isolate and enhance one or more selected regions (views) taken from the panoramic image data. In one embodiment, each view is specified with three parameters: Pan angle, which is the horizontal direction in which the view is centered; the Tilt angle, which is the vertical direction (usually in degrees from the horizon) in which the view is centered, and the Zoom factor, which is how much the image is magnified within the view to be generated. Using the Pan, Tilt and Zoom (PTZ) information, the region with the panoramic image that is needed for generating a selected view is easily identified (block 823) and perspective corrected (block 825) using techniques known to those skilled in the art of image processing. In one embodiment, an optional Keystone correction is then applied to the image data of each view (block 827). This Keystone correction compensates for distortion typically generated in panoramic image data that creates a sensation of looking up—that is, the affect one notices when standing next to a tall build and looks up. The same horizontal features that are at the bottom of an image appear much smaller at the top of the image. Because visual conferencing station 100 is typically placed on a table at a height that is relatively low compared to the ceiling of a typical conference room, if only a perspective corrected view were generated, then persons viewing the generated view will have the sensation of always looking up to the people in the displayed view of the other conference room. To correct for Keystone distortion, one needs to keep in mind that keystone distortion, by itself, is a linear affect. In the most common and obvious case, features in an image are horizontally narrower at the top than at the bottom. The easiest way to correct for this affect, by itself, would be to map the left and right edges of a destination image (the Keystone corrected image) into the source image such that the left and right edges of the mapped source lines follow lines of longitude, or great circles, within the source image. If one were to show this in a graphical representation, the mapping of the destination image would form a symmetric quadrilateral, with the top and bottom lines parallel to each other, within the source image. Then, a bilinear interpolation method is used to compute the pixel addressing within the quadrilateral (i.e., to affectively stretch the top of the quadrilateral in the source image to fit within the rectangle of the destination image). By applying this Keystone correction, the Keystone distortion is effectively removed and the sensation of looking up is also removed. Note that some small visual cues still remain in the Keystone corrected image data due to the positional height of the lens system from the table. However, the removal of the Keystone distortion is so effective one hardly notices these visual cues, and gets the sensation of looking straight into the faces of the conference participants at the other site. Note also that, although indicated as a separate process in FIG. 8A, in another embodiment this Keystone correction process is combined into the perspective view generation equations to take care of view generation and Keystone correction simultaneously, thus making the entire view generation process more efficient. Finally, the fully compensated and corrected image view is transmitted to an assigned region of the display screen (block 829).

FIG. 8B is an exemplary “screenshot” 800 showing visual display features associated with the present invention. Located along a bottom of the screen is a navigation bar that provides a user several display control selections, including the indicated format in which a panoramic image 810 is positioned immediately above the navigation bar, and four views 830 located above the panoramic image, each view 830 capturing the image of an associated meeting participant. In accordance with another aspect of the present invention, the location of a current speaker 835 is identified by the three microphones mounted on the station housing using known triangulation techniques, and the current speaker is highlighted (e.g., by superimposing a red border around the associated view) for easy identification. Other features and aspects associated the various display options provided by the visual conferencing station of the present invention are disclosed in co-owned and co-pending U.S. patent application Ser. No. xx/xxx,xxx entitled “RECEIVING SYSTEM FOR VIDEO CONFERENCING SYSTEM” by Robert G. Hoffman et al. [Atty Docket No. BEH-020], which is incorporated herein in its entirety.

One skilled in the art will understand that FIG. 5 through FIG. 8A describe aspects of the embodiment shown in FIG. 3A. Such a one would also understand how to adapt these aspects for the embodiment shown in FIG. 3B. One adaptation is that the local visual conference station 301 and the remote visual conference station 303 do not communicate directly but instead each communicates with the visual conferencing server 309. Another adaptation can be that neither the local visual conference station 301 nor the remote visual conference station 303 transform the annular or wide-angle image to a panoramic image. Instead, the annular or wide-angle image is compressed and sent to the visual conferencing server 309 where the image is decompressed and transformed into a panoramic image. The visual conferencing server 309 then compresses the panoramic image and sends it to the remote visual conference station 303 (or more than one remote station). Such a one will also understand how to automatically determine whether the local visual conference station 301 is connecting directly with the remote visual conference station 303 or to a visual conferencing server 309 and appropriately condition the procedures. Further, one skilled in the art after reading the forgoing will understand that the visual information exchanged between the visual conference stations can include computer-generated visual information (for example, a computer-generated presentation that generates images corresponding to that projected onto a screen).

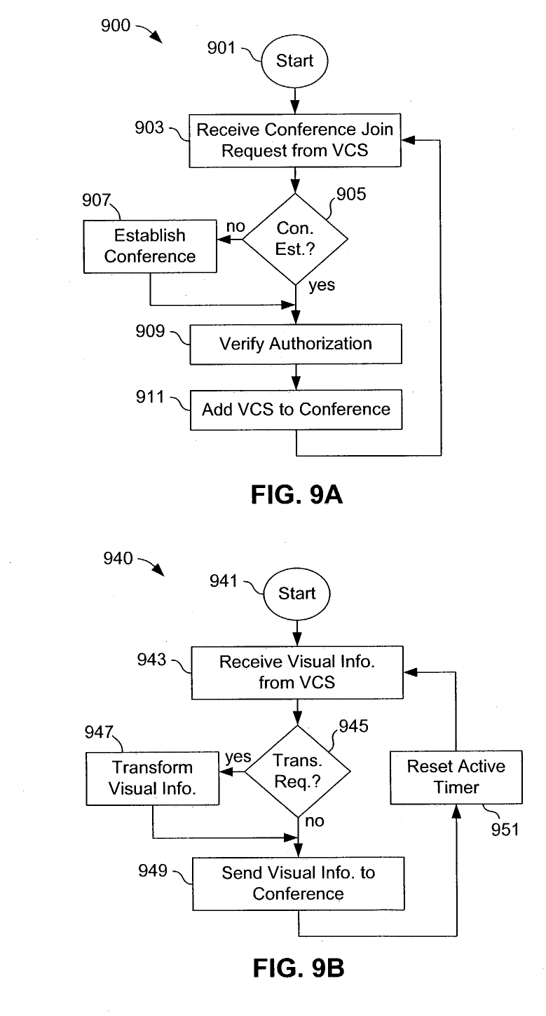

FIG. 9A illustrates a ‘conference registration’ process 900 that can be used by the visual conferencing server 309 to establish a conference. The ‘conference registration’ process 900 can be used with Internet, local area network, telephone or other protocols. The conference registration’ process 900 initiates at a ‘start’ terminal 901 and continues to a ‘receive conference join request’ procedure 903 that receives and validates (verifies that the provided information is in the correct format) a request from a visual conference station to establish or join a conference. Generally, the information in the request includes a conference identifier and an authorization code (along with sufficient information needed to address the visual conference station making the request).

Next, a ‘conference established’ decision procedure 905 determines whether the provided information identifies an existing conference. If the identified conference is not already established, the ‘conference registration’ process 900 continues to an ‘establish conference’ procedure 907 that examines the previously validated join request and verifies that the visual conference station making the join request has the capability of establishing the conference. The ‘establish conference’ procedure 907 also determines the properties required for others to join the conference. One skilled in the art will understand that there are many ways that a conference can be established. These include, but are not limited to, the conference organizer including a list of authorized visual conference station addresses, providing a conference name and password, and other validation schemas known in the art. If this verification fails, the ‘conference registration’ process 900 processes the next join request (not shown).

Once the conference is established, or if the conference was already established, the ‘conference registration’ process 900 continues to a ‘verify authorization’ procedure 909 that examines the previously validated information in the join request to determine whether the visual conference station making the join request is authorized to join the identified conference. If this verification fails, the ‘conference registration’ process 900 processes the next join request (not shown).

If the join request is verified, the ‘conference registration’ process 900 continues to an ‘add VCS to conference’ procedure 911 that adds the visual conference station making the request to the conference. Then the ‘conference registration’ process 900 loops back to the receive conference join request’ procedure 903 to handle the next join request.

One skilled in the art will understand that there are many ways, equivalent to the one illustrated in FIG. 9A, for establishing a conference.

FIG. 9B illustrates a ‘distribute visual information’ process 940 can be used to receive visual information from each visual conference station in the conference and to distribute the visual information to each of the member conference stations. The ‘distribute visual information’ process 940 can be used, without limitation, to receive the visual information from one member conference station and distribute that information to all the other member conference stations, or all the other member conference stations as well as the one member conference station; to exchange visual information between two member conference stations; and/or to exchange visual information between all member conference stations (subject to the amount of visual information that can be displayed, or operator parameters at a particular visual conference station).

The ‘distribute visual information’ process 940 initiates at a ‘start’ terminal 941 and continues to a ‘receive visual information from VCS’ procedure 943 that receives visual information from a visual conference station. The visual information is examined at a ‘transformation required’ decision procedure 945 to determine whether the visual information is in a rectangular panoramic form and need not be transformed. If the visual information is not in a rectangular panoramic form (thus, the server is to perform the transformation) the ‘distribute visual information’ process 940 continues to a ‘transform visual information’ procedure 947 provides the transformation from the annular or wide-angle format into a rectangular panoramic image and performs any required compression. Regardless of the branch taken at the ‘transformation required’ decision procedure 945, the ‘distribute visual information’ process 940 continues to a ‘send visual information to conference’ procedure 949 where the panoramic image is selectively sent to each of the member conference stations (possibly including the visual conference station that sent the visual information) based on the conference parameters.

The ‘distribute visual information’ process 940 then continues to a ‘reset active timer’ procedure 951 that resets a timeout timer. The timeout timer is used to detect when the conference is completed (that is, when no visual information is being sent to the visual conferencing server 309 for a particular conference). One skilled in the art will understand that there exist many other ways to detect when the conference terminates extending from explicit ‘leave’ commands to time constraints. After the timer is reset, the ‘distribute visual information’ process 940 loops back to the ‘receive visual information from VCS’ procedure 943 to receive the next visual information for distribution.

One skilled in the art after reading the forgoing will understand that visual information includes video information of any frame rate, sequences of still images, and computer generated images. In addition, such a one will understand that the described procedures can be implemented as computer programs executed by a computer, by specialized circuitry, or some combination thereof.

One skilled in the art after reading the forgoing will understand that there are many configurations of the invention. These include, but are not limited to:

A configuration where a device containing the visual processing portion of the invention is in communication with a standard speakerphone or audio conferencing device (through, for example, but without limitation, a phone line, an infrared communication mechanism or other a wireless communication mechanism). Thus, this configuration can be viewed as an enhancement to an existing audio conference phone.

A configuration where a separate computer reads the image sensor and provides the necessary visual information processing and communication.

A configuration where the visual conference station 100 includes wire or wireless connections for external computer/video monitors and/or computers (such that computer presentation at one conference station can be made available to each of the visual conference stations; and such that the panoramic image can be presented on projection monitors or on a personal computer in communication with the visual conference station.

A configuration where the visual conference station 100 includes a general-purpose computer.

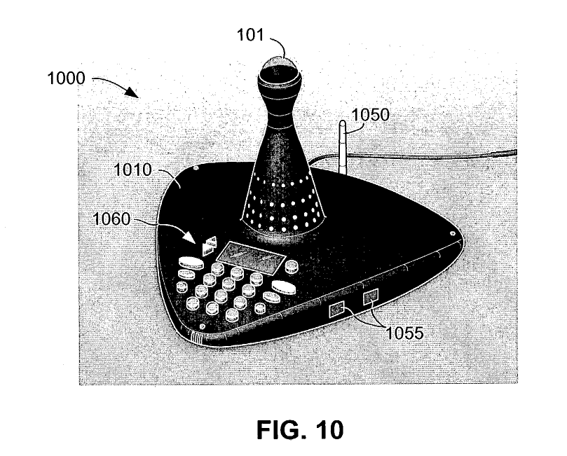

FIG. 10 is a perspective view showing an exemplary visual conference station 1000 according to yet another embodiment of the present invention. Visual conference station 1000 includes a panoramic lens 101 mounted on a housing 1010 for capturing light from substantially 360-degree (panoramic) region in the manner described above with reference to visual conference station 100. However, unlike visual conference station 100, visual conference station 1000 does not include touchscreen display devices for displaying visual data and/or controlling station operations. Instead, visual conference station 1000 is adapted to transmit panoramic image data to one or more conventional laptop devices (not shown) by means of wireless communication (e.g., via antenna 1050), or by wired connection (e.g., using UBS ports 1055 provided on a side surface of housing 1010). In addition, a keypad 1060 is provided on housing 1010 for entering instructions utilized to control station operations. Aside from these differences, visual conference station 1000 operates essentially as described above with reference to visual conference station 100.

From the foregoing, it will be appreciated that the invention has (without limitation) the following advantages:

It returns the “videoconference” format to the natural “people-around-a-table” meeting arrangement where people face each other, rather than causing a room full of people to face a selected wall. The participants at the remote site are displayed in front of the participants at the local site using small, detachable display devices that provide individual navigation and screen control that allow a viewer to manually select and enhance a particular region of interest (e.g., a current speaker) without requiring distracting camera movement. Thus, the peopled attending the conference look across the table at each other, and interact in a natural manner, rather than focusing on a single large monitor located at the end of the conference room.

It is simpler and less expensive than the prior art videoconferencing systems. It also has a smaller, more acceptable footprint (equivalent to the ubiquitous teleconferencing phones in most meeting rooms).

It answers the basic question of most meetings: who is attending the meeting, who is speaking, and what the body language and other non-verbal cues are being made by the other participants.

Unlike the use of robotic cameras, it has no moving parts, makes no noise and thus does not distract the meeting participants.

The panoramic lens completely automatic and thus, requires no manual or assisted steering, zooming or adjustment of the camera or lens.

It gracefully recovers from network problems in that it naturally degrades back to conventional teleconferencing, as opposed to having the meeting collapse because of a lost network connection.

It can use well-developed video streaming protocols when using JP network environments.

In addition to performing two-station visual conferencing functions, it can be utilized to record and playback meetings, allowing the same virtual camera display options, but in a retrospective imagery setting rather than a remote imagery setting. Such replays could be played over and over, allowing a detail investigation of participant reactions.

Although the present invention has been described in terms of the presently preferred embodiments, one skilled in the art will understand that various modifications and alterations may be made without departing from the scope of the invention. Accordingly, the scope of the invention is not to be limited to the particular invention embodiments discussed herein.

What is claimed is:

1. A visual conference station adapted to rest on a flat surface, the visual conference station including a panoramic imaging system for recording light received from a panoramic region surrounding the visual conference station, wherein the panoramic imaging system comprises:
a panoramic lens having an optical axis aligned perpendicular to the flat surface; and
an image sensor located below the panoramic lens and adapted to capture panoramic image data received from the panoramic lens.

2. The visual conference station according to claim 1, wherein the panoramic lens comprises:
a convex aspheric surface symmetrical about the optical axis, the convex aspheric surface comprising a first transmissive portion surrounding a first internally reflective portion; and
a concave aspheric surface symmetrical about the optical axis, the concave aspheric surface comprising a second internally reflective portion surrounding a second transmissive portion.

3. The visual conference station of claim 2,
wherein the second internally reflective portion is adapted to reflect light received through the first transmissive portion to the first internally reflective portion, and
wherein the first internally reflective portion is adapted to reflect light received through the second internally reflective portion to the second transmissive portion.

4. The visual conference station of claim 2, wherein the panoramic imaging system further comprises a secondary set of optical elements aligned along the optical axis and adapted to provide an optical path between the image sensor and the panoramic lens.

5. The visual conference station of claim 4, wherein the secondary set of optical elements comprises at least one of a image flattening lens, a scaling lens, a color correcting lens set, and an infrared filter.

6. The visual conference station according to claim 1, wherein the panoramic lens is adapted to generate an anamorphic annular image onto the image sensor.

7. The visual conference station according to claim 6, further comprising means for processing anamorphic annular image data captured by the image sensor, and for producing panoramic image data adapted to generate a rectangular panoramic image on a display device.

8. The visual conference station according to claim 1, further comprising a plurality of microphones for capturing audio signals.

9. The visual conference station according to claim 8, further comprising means for automatically identifying a location of an object by comparing a plurality of audio signals captured by the plurality of microphones in response to sound emitted from the object, and triangulating the location based on relative signal strengths of the audio signals.

10. The visual conference station according to claim 1, further comprising processing means for transmitting the panoramic image data captured by the panoramic imaging system onto a communication network, and for receiving second panoramic image data from an external source.

11. The visual conference station according to claim 10, further comprising a visual display device for displaying said second panoramic image data.

12. The visual conference station according to claim 11, wherein said visual display device comprises a touchscreen device adapted to receive commands from a user, and to transmit the commands to the processing means.

13. The visual conference station according to claim 12, wherein the visual display device comprises means for isolating and enhancing a selected region of the panoramic image data.

14. The visual conference station according to claim 13, wherein said means for isolating and enhancing the selected region of the panoramic image data comprising at least one of a means for compensating the image data associated with the selected region for a selected zoom parameter, means for compensating the image data associated with the selected region for a selected tilt angle, and means for performing Keystone correction on the image data associated with the selected region.

15. A visual conference station comprising:
a housing adapted to rest on a flat surface, the housing including a base and a central post extending upward from the base;
a panoramic lens mounted on an upper end of the central post; and
an image sensor mounted inside of the central post below the panoramic lens,
wherein the panoramic lens is adapted to receive light from a panoramic region surrounding the visual conference station, and to direct the received light in an annular pattern onto the image sensor.

16. The visual conference station according to claim 15, wherein the central post is constructed such that the panoramic lens is maintained a distance in the range of four to 16 inches above the flat surface.

17. The visual conference station according to claim 16, wherein the panoramic lens is maintained a distance in the range of eight to 12 inches above the flat surface.

18. The visual conference station according to claim 17, wherein the panoramic lens defines an optical axis aligned perpendicular to the flat surface, and wherein the panoramic lens comprises:
a convex aspheric surface symmetrical about the optical axis, the convex aspheric surface comprising a first transmissive portion surrounding a first internally reflective portion; and
a concave aspheric surface symmetrical about the optical axis, the concave aspheric surface comprising a second internally reflective portion surrounding a second transmissive portion.

19. The visual conference station of claim 18,
wherein the second internally reflective portion is adapted to reflect light received through the first transmissive portion to the first internally reflective portion, and
wherein the first internally reflective portion is adapted to reflect light received through the second internally reflective portion to the second transmissive portion.

20. The visual conference station according to claim 19, further comprising a secondary set of optical elements aligned along the optical axis and adapted to provide an optical path between the image sensor and the panoramic lens.

21. The visual conference station of claim 20, wherein the secondary set of optical elements comprises at least one of a image flattening lens, a scaling lens, a color correcting lens set, and an infrared filter.

22. The visual conference station according to claim 15, wherein the panoramic lens is adapted to generate an anamorphic annular image onto the image sensor.

23. The visual conference station according to claim 22, further comprising means for processing anamorphic annular image data captured by the image sensor, and for producing panoramic image data adapted to generate a rectangular panoramic image on a display device.

24. The visual conference station according to claim 15,
wherein the housing further comprises a plurality of foot portions extending radially outward from the base, and
wherein the visual conference station further comprises a plurality of microphones for capturing audio signals, each of the plurality of microphones being located adjacent to an end of a corresponding foot portion.

25. The visual conference station according to claim 24, further comprising means for automatically identifying a location of an object by comparing a plurality of audio signals captured by the plurality of microphones in response to sound emitted from the object, and triangulating the location based on relative signal strengths of the audio signals.

26. The visual conference station according to claim 15, further comprising:
processing means for converting annular image data captured by the image sensor into panoramic image data and for compressing the panoramic image data;
transmission means for transmitting the compressed panoramic image data onto a communication network; and
receiving means for receiving second panoramic image data from an external source,
wherein the processing means further comprises means for decompressing said second panoramic image data.

27. The visual conference station according to claim 26, further comprising a visual display device for displaying said second panoramic image data.

28. The visual conference station according to claim 27, wherein said visual display device comprises a touchscreen device adapted to receive commands from a user, and to transmit the commands to the processing means.

29. The visual conference station according to claim 28, wherein the visual display device comprises means for isolating and enhancing a selected region of the panoramic image data.

30. The visual conference station according to claim 29, wherein said means for isolating and enhancing the selected region of the panoramic image data comprising at least one of a means for compensating the image data associated with the selected region for a selected zoom parameter, means for compensating the image data associated with the selected region for a selected tilt angle, and means for performing Keystone correction on the image data associated with the-selected region.

31. A visual conference station comprising:
a panoramic imaging system for reflecting light received from a panoramic region surrounding the visual conference station onto an image sensor such that the reflected light is projected in an annular pattern onto the image sensor;
processing means for converting annular image data captured by the image sensor into panoramic image data adapted to generate a rectangular panoramic image on a display device; and
means for transmitting the panoramic image data onto a communication network.

32. The visual conference station according to claim 31, wherein the panoramic imaging system includes a panoramic lens defining an optical axis aligned perpendicular to the flat surface, and wherein the panoramic lens comprises:
a convex aspheric surface symmetrical about the optical axis, the convex aspheric surface comprising a first transmissive portion surrounding a first internally reflective portion; and
a concave aspheric surface symmetrical about the optical axis, the concave aspheric surface comprising a second internally reflective portion surrounding a second transmissive portion.

33. The visual conference station of claim 32,
wherein the second internally reflective portion is adapted to reflect light received through the first transmissive portion to the first internally reflective portion, and
wherein the first internally reflective portion is adapted to reflect light received through the second internally reflective portion to the second transmissive portion.

34. The visual conference station of claim 32, wherein the panoramic imaging system further comprises a secondary set of optical elements aligned along the optical axis and adapted to provide an optical path between the image sensor and the panoramic lens.

35. The visual conference station of claim 34, wherein the secondary set of optical elements comprises at least one of a image flattening lens, a scaling lens, a color correcting lens set, and an infrared filter.

36. The visual conference station according to claim 31, wherein the panoramic lens is adapted to generate an anamorphic annular image onto the image sensor.

37. The visual conference station according to claim 36, further comprising means for processing anamorphic annular image data captured by the image sensor, and for producing panoramic image data adapted to generate a rectangular panoramic image on a display device.

38. The visual conference station according to claim 31, further comprising a plurality of microphones for capturing audio signals.

39. The visual conference station according to claim 38, further comprising means for automatically identifying a location of an object by comparing a plurality of audio signals captured by the plurality of microphones in response to sound emitted from the object, and triangulating the location based on relative signal strengths of the audio signals.

40. The visual conference station according to claim 31, further means for receiving second panoramic image data from an external source.

41. The visual conference station according to claim 40, further comprising a visual display device for displaying said second panoramic image data.

42. The visual conference station according to claim 41, wherein said visual display device comprises a touchscreen device adapted to receive commands from a user, and to transmit the commands to the processing means.

43. The visual conference station according to claim 42, wherein the visual display device comprises means for isolating and enhancing a selected region of the panoramic image data.

44. The visual conference station according to claim 43, wherein said means for isolating and enhancing the selected region of the panoramic image data comprising at least one of a means for compensating the image data associated with the selected region for a selected zoom parameter, means for compensating the image data associated with the selected region for a selected tilt angle, and means for performing Keystone correction on the image data associated with the selected region.
